(19) United States
(12) Patent Application Publication
(10) Pub. No.: US 2015/0085603 A1
(43) Pub. Date: Mar. 26, 2015

(54) SYSTEMS AND METHODS FOR DETERMINING THE FAR FIELD SIGNATURE OF A SOURCE IN WIDE AZIMUTH SURVEYS

(71) Applicant: CGG Services SA, Massy Cedex (FR)

(72) Inventors: Anne Vesin, Palaiseau (FR); Karine Desrues, Singapore (SG)

(21) Appl. No.: 14/495,923

(22) Filed: Sep. 25, 2014

Related U.S. Application Data
(60) Provisional application No. 61/882,111, filed on Sep. 25, 2013.

(51) Int. Cl. G01V 1/38; G01V 1/34; G01V 1/28

(52) U.S. Cl. CPC G01V 1/3835; G01V 1/28; G01V 1/345
USPC 367/7; 367/15; 367/21

(57) ABSTRACT

Systems and methods for determining the far field signature of a source in wide azimuth surveys are disclosed. The method includes determining a position of a first sensor and a source. The first sensor is attached to a first vessel and the source is attached to a second vessel. The method further includes calculating a reflected incidence angle between the first sensor and the source, determining a position for a second sensor based on a direct incidence angle between the second sensor and the source approximating the direct incidence angle. The method also includes determining a far field signature for the source based on the direct incidence angle.

### CROSS-REFERENCE TO RELATED APPLICATION

This application claims the benefit under 35 U.S.C. §119(e) of U.S. Provisional Application Ser. No. 61/882,111 filed on Sep. 25, 2013, which is incorporated by reference in its entirety for all purposes.

### TECHNICAL FIELD

The present disclosure relates generally to seismic exploration and, more particularly, to systems and methods for determining the far field signature of a source in wide azimuth surveys.

### BACKGROUND

In recent years, offshore drilling has become an increasingly important method of locating and retrieving oil and gas. But because drilling offshore involves high costs and high risks, marine seismic surveys are used to produce an image of subsurface geological structures. While the image may not directly show the location of oil or gas, those trained in the field can use such images to more accurately predict the location of oil and gas and thus reduce the chance of drilling a non-productive well.

Marine seismic surveys are usually accomplished by marine survey ships towing a signal source and/or seismic sensors. Some marine seismic surveys may involve multiple marine survey ships and may include source vessels that tow signal sources and recording vessels that tow seismic sensors and can, in some configurations, also tow sources. Each seismic sensor, or “sensor,” may be a hydrophone, which detects variations in pressure below the ocean surface. The sensors are contained within or attached to a cable that is towed behind the moving ship. The cables are often multiple kilometers in length and each has many sensors. The towing process is referred to as “streaming” the cable, and the cables themselves are referred to as “streamer cables” or “streamers.” For example, typically streamers can be approximately three to twelve kilometers in length. The distance between streamers perpendicular to the direction of movement of the recording vessel may be referred to as the “crossline streamer separation.” The total crossline distance from the first streamer to the last streamer may be referred to as “spread width.” For example, a recording vessel may tow approximately eight streamers at approximately seventy-five meter crossline streamer separation for a total spread width of approximately 500 hundred to 600 hundred meters. Spread widths can be designed up to approximately 1,200 meters.

A recording vessel may tow streamer cables at the same depth or at different depths. One or multiple depth positioning devices can act to hold portions of the streamer cable below the ocean surface at a desired depth. Streamer cables may be positioned at a constant depth below the ocean surface, or they may have a variable depth profile, according to the design of the survey. For example, a particular sensor may be towed on a towing line or a streamer cable at an approximately constant depth of 250 meters.

Source vessels can also tow one or more sources. The source generates a seismic signal, which is a series of seismic waves that travel in various directions including toward the ocean floor. The seismic waves penetrate the ocean floor and are at least partially reflected by interfaces between subsurface layers having different seismic wave propagation speeds. Sensors detect and receive these reflected waves. Sensors transform the seismic waves into seismic traces suitable for analysis. Sensors are in communication with a computer or recording system, which records the seismic traces from each sensor.

Each seismic trace typically contains contributions corresponding to multiple reflected waves that travel different paths from the source to the seismic sensor. For example, a given sensor may detect waves reflected from an interface at a shallow depth below the surface at one time, and detect waves reflected from an interface at a deeper depth at a later time. The arrival times of the waves travelling along each path may be affected by a variety of factors including the composition of the subsurface layers along each path, the depths and thicknesses of the layers along each path, the angle of the incoming wave, and other factors.

A seismic source has a characteristic far field signature that assists in processing of seismic data acquired by sensors. A signature for a particular source is the shape of the signal emitted by the seismic source and transmitted in the body of water. The signature varies with distance and azimuth from the seismic source. When the signature achieves and maintains a stable shape, it is referred to as the “far field” signature. This occurs at a certain distance from the point of source signal emission and when the water depth is sufficient to avoid the perturbation of the wave refracted by the sea floor.

Different techniques can be used to obtain the far field signature. For example, the far field signature can be modelled through dedicated source modelling software, reconstructed with a mathematical method from the individual signal recorded on each air gun, or in some cases, directly measured. In the case of direct measurement, a single sensor (hydrophone) or a group of single sensors positioned in the body of water at a certain distance from the source may be used to record the “true” signal emitted by the source. The sensors transform the waves emitted by the source into a signal suitable for analysis. When the sensor is positioned at a distance sufficiently far from the source, e.g., approximately 250 meters, the sensor may be used to determine the “true” far field signature of the source.

In wide azimuth (WAZ) survey, an increase in azimuthal range is accomplished by acquiring data over the same subsurface area using multiple recording vessels and source vessels. Azimuth is defined as the angle in a horizontal plane between the seismic source and the place where the reading is taken, relative to some datum angle, for example north. For WAZ surveys, multiple passes are acquired with increasing lateral separation between the recording vessels and source vessels to build up a range of offsets and azimuths. Thus, WAZ surveys use one or more recording vessels to tow sensors to detect and record seismic signals, and one or more source vessels that generally travel parallel to, but at some specified distance from the recording vessels. By making successive passes over the target, increasing the offset between the recording vessels and the source vessels by the width of the streamer spread each time, a wider range of azimuths and offsets are obtained.

However, in WAZ surveys, determining the far field signature at the azimuth angles may be difficult. Additionally, approximating the far field signature for these angles produces inferior data regarding the subsurface than would be obtained using the actual far field signature. Thus, there is a need for a technique to improve determination of the far field signature of a source at relevant angles from vertical for identification and analysis of subsurface formations.

### SUMMARY

In accordance with some embodiments of the present disclosure, a method for seismic data processing is disclosed. The method includes determining a position of a first sensor and a source. The first sensor is attached to a first vessel and the source is attached to a second vessel. The method further includes calculating a reflected incidence angle between the first sensor and the source, determining a position for a second sensor based on a direct incidence angle between the second sensor and the source approximating the direct incidence angle. The method also includes determining a far field signature for the source based on the direct incidence angle.

In accordance with another embodiment of the present disclosure, a seismic survey system includes a source configured to emit seismic waves, a first sensor and a second sensor configured to transform seismic waves into a recorded signal, and a computing system. The computing system includes a processor, a memory communicatively coupled to the processor, and instructions stored in the memory. The instructions, when executed by the processor, cause the processor to determine a position of the first sensor and the source. The first sensor is attached to a first vessel and the source is attached to a second vessel. The processor is also caused to calculate a reflected incidence angle between the first sensor and the source, determine a position for a second sensor based on a direct incidence angle between the second sensor and the source approximating the reflected incidence angle, and determine a far field signature for the source based on the direct incidence angle.

In accordance with another embodiment of the present disclosure, a non-transitory computer-readable medium includes instructions that, when executed by a processor, cause the processor to determine a position of a first sensor and a source. The first sensor is attached to a first vessel and the source is attached to a second vessel. The processor is also caused to calculate a reflected incidence angle between the first sensor and the source, determine a position for a second sensor based on a direct incidence angle between the second sensor and the source approximating the reflected incidence angle, and determine a far field signature for the source based on the direct incidence angle.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1A illustrates an elevation view of an example marine seismic survey system used for conducting a wide azimuth (WAZ) survey and measuring the far field signature in accordance with some embodiments of the present disclosure;

FIG. 1B illustrates an exemplary side view of the example marine seismic survey system of FIG. 1A in accordance with some embodiments of the present disclosure;

FIG. 1C illustrates an exemplary elevation view of an example marine seismic survey system used for measuring the far field signature at varied direct incidence angles in accordance with some embodiments of the present disclosure;

FIGS. 2A-2E illustrate exemplary views of configurations of source vessels and recording vessels used to determine the far field signature of a source in accordance with some embodiments of the present disclosure;

FIG. 3 illustrates a flow chart of an example method for determining the far field signature of a source in accordance with some embodiments of the present disclosure; and

FIG. 4 illustrates a schematic of an example seismic imaging system that can be used to determine the far field signature of a source in accordance with some embodiments of the present disclosure.

### DETAILED DESCRIPTION

The present disclosure is directed to methods and systems of determining the far field signature of a seismic source at varied direct incidence angles. The system of the present disclosure can be utilized to determine the far field signature of a source at angles other than vertical. The system is useful in wide azimuth (WAZ) surveys because the far field signature can be determined with similar azimuths that are used in gathering seismic data during production. As discussed above, determining the far field signature of a source for an increased range of direct incidence angles seen during WAZ surveys provides additional details that can be used to improve the resulting seismic data. For example, for data gathered at a specified angle from vertical, the far field signature for that angle may be applied to the data rather than the far field signature measured at vertical leading to improvements in accuracy of the resultant data.

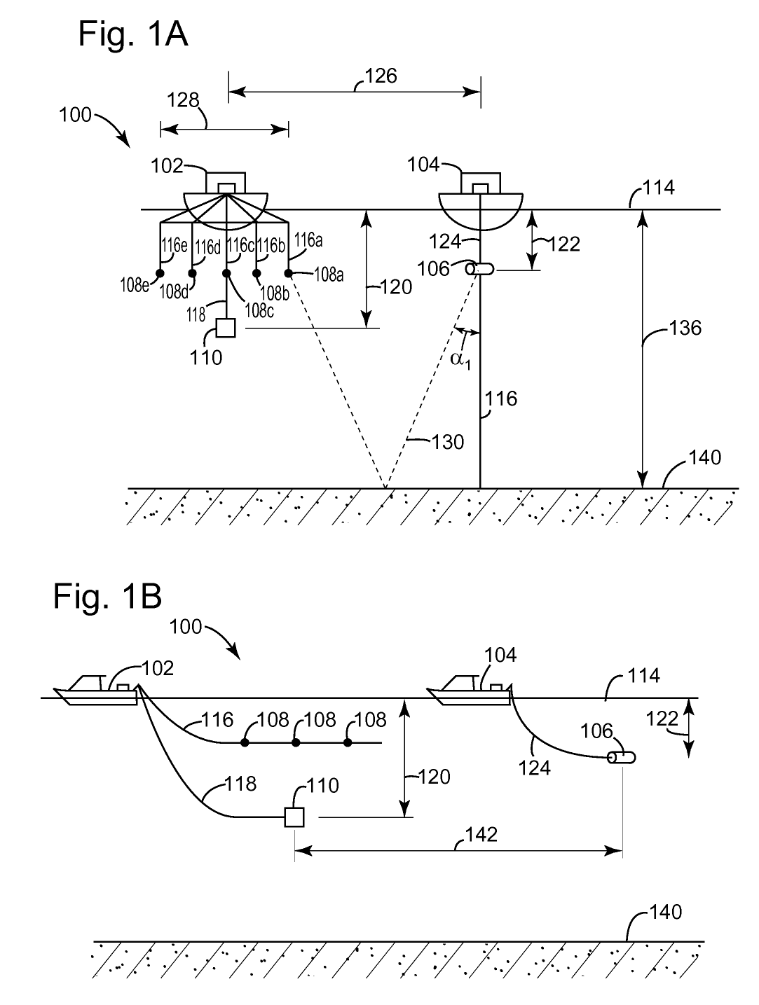

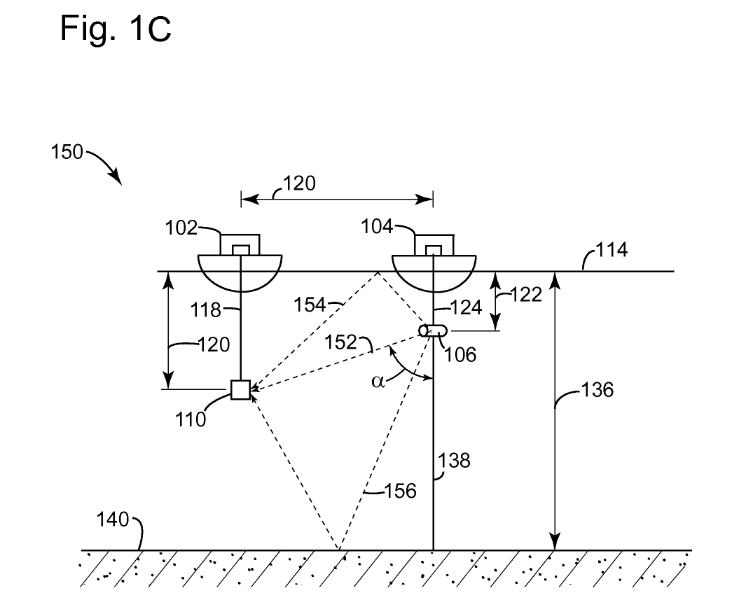

FIG. 1A illustrates an elevation view of an example marine seismic survey system 100 used for conducting a WAZ survey and measuring the far field signature in accordance with some embodiments of the present disclosure. Source vessel 104 and recording vessel 102 are oriented to show the rear of the vessels. Source vessel 104 includes signal source 106. Although only one source 106 is shown, it should be understood that system 100 may comprise multiple sources 106. Sources 106 may also be referred to as “seismic sources,” “energy sources,” or “seismic energy sources.” Seismic survey system 100 may include sensors 108a-108e (collectively referred to as “sensors 108”). Source 106 and sensors 108 may be configured to conduct a WAZ survey. Sensors 108 may be attached to and towed behind recording vessel 102 and positioned relative to source 106

In some embodiments, seismic survey system 100 may include a single hydrophone (or closely spaced group of hydrophones) shown as sensor 110 to measure the far field signature of source 106. Sensor 110 may be attached to recording vessel 102 via towing line 118. Sensor 110 may be towed behind recording vessel 102 and positioned relative to source 106.

In some embodiments, sensors 108 may be positioned with any appropriate combination of crossline streamer offset (perpendicular to direction of travel of recording vessel 102), inline offset (along the direction of travel of recording vessel 102 discussed with reference to FIG. 1B), and depth offset from sources 106 or water surface 114. Sensors 108 may be attached or connected to recording vessel 102 via streamer lines 116a-116e (collectively “streamer lines 116”). Although only one sensor 108 is shown per streamer line 116, any appropriate number of sensors 108 may be coupled to a particular streamer line 116. In some embodiments, sensors 108 may be maintained in a selected position or location using any suitable positioning system. Sensors 108 may be configured to receive seismic signals to generate seismic data, but may not be configured to determine a far field signature.

In some embodiments, sensor 110 may be configured to determine the far field signature of source 106. Sensor 110 may be attached or connected to recording vessel 102 with towing line 118 (or towing lines 118 for several closely spaced sensors 110). Towing line 118 may also be combined with a data line to provide real time monitoring of the acquired data. Sensor 110 may be positioned and maintained at a particular depth. For example, sensor 110 may be maintained at sensor depth 120 of approximately 250 meters. In some embodiments, sensor 110 may consist of multiple closely spaced sensors 110. Although shown in the illustrated embodiments to be on the same recording vessel 102 as sensors 108, in some embodiments, recording vessel 102 may not include sensors 108.

In some embodiments, source 106 may be at a particular source depth 122 below the water surface 114, for example approximately ten meters. Source 106 may be attached to source vessel 106 via source towing line 124. Source 106 can include an array of seismic energy sources towed behind source vessel 104. Multiple sources 106 may be at varied depths below surface 114. Although only one source 106 is shown on source towing line 124, any appropriate number of sources 106 may be connected to a particular source towing line 124. Additionally, multiple sources 106 may be positioned at a predetermined distance from one another, for example approximately three meters.

In some embodiments, the positions of sources 106 and sensors 108 and 110 are monitored using one or more position-measurement mechanisms. For example, system 100 may include an ultra-short baseline (USBL), which measures an angle and distance to each source 106 or sensor 108 and 110 using acoustic pulses. System 100 may also include depth sensors, GPS sensors, visible light or infrared transceivers, or any other mechanisms suitable for measuring the positions of sources 106 and sensors 108 and 110.

Seismic survey system 100 illustrates one of the possible vessel arrangements during a WAZ survey. A WAZ survey may include multiple source vessels 104 and recording vessels 102 arranged such that multiple passes are performed over a survey area. With each successive pass, offset distance 126 (also referred to as “lateral separation”) between sources 106 and sensors 108 may increase to build up the range of offsets and azimuths. For example, two source vessels 104 may be operated to tow different sets of sources 106 parallel to each other. Two recording vessels 102 may be operated on either side of the two source vessels 104, such that with each successive pass the offset distance 126 between a particular sensor, and a source 106 is increased by spread width 128. Spread width 128 may be the total distance of the separation between streamer lines 116. For example, spread width 128 may be the distance between streamer line 116a and 116e, or approximately 600 meters. In some embodiments, seismic survey system 100 is configured to measure the far field signature of a source used in a WAZ survey and not conducting the WAZ survey itself. For example, a configuration that does not include sensors 108 or streamer lines 116 may be operated to determine the far field signature of a source used in a WAZ survey as discussed in detail with reference to FIG. 1C.

During a WAZ survey, signals emitted from source 106 are reflected from the ocean bottom 140 and received by sensors 108 as reflected waves 130. The distance between sensors 108 and source 106 and the water depth 136 creates a reflected incidence angle α₁ from vertical 138, which is a vertical line from source 106 to ocean floor 140. Because the seismic signals are received at sensors 108 based on the reflected incidence angle α₁, understanding the far field signature at the reflected incidence angle α₁ allows for increased accuracy in analysis of seismic data. The reflected incidence angle α₁ for reflected wave 130 may be calculated using the following:

$${∝}_{1} = {tan}^{- 1} ( \frac{( D + SW ) / 2}{WD} )$$

where D is offset distance 126, SW is streamer width 128, and WD is water depth 136.

FIG. 1B illustrates an exemplary side view of the example marine seismic survey system 100 of FIG. 1A in accordance with some embodiments of the present disclosure. System 100 in the view of FIG. 1B includes recording vessel 102 and source vessel 104. Recording vessel 102 and source vessel 104 are oriented to show the sides of the vessels. Source 106 is towed on line 124 at source depth 122 from water surface 114. Sensors 108 are towed by streamer lines 116. Sensor 110 is towed by towing line 118 at sensor depth 120. Inline offset 142 is the inline distance between source 106 and sensor 110. In some embodiments, source vessel 104 (and source 106) may be positioned in front of recording vessel 102 (and sensor 110). In some embodiments, source vessel 104 and recording vessel 102 may be positioned such that source 106 and sensor 110 are substantially parallel (e.g., inline offset 142 may be approximately zero meters).

FIG. 1C illustrates an elevation view of an example marine seismic survey system 150 used for measuring the far field signature at varied direct incidence angles in accordance with some embodiments of the present disclosure. Seismic survey system 150 is configured to measure the far field signature to be used in analysis of seismic data obtained during a WAZ survey. As such, seismic survey system 150 may not include sensors 108 and streamer lines 116 that are shown with reference to FIG. 1A. Source vessel 104 and recording vessel 102 are oriented to show the rear of the vessels. Source vessel 102 includes signal source 106. Although only one source 106 is shown, it should be understood that system 150 may comprise multiple sources 106. Sensor 110 may include a single hydrophone (or closely spaced group of hydrophones) and may be towed behind recording vessel 102 and positioned relative to source 106.

In some embodiments, sensor 110 may be positioned with any appropriate combination of crossline offset (perpendicular to direction of travel of recording vessel 102), inline offset (along the direction of travel of recording vessel 102 discussed with reference to FIG. 1B), and depth offset from sources 106 or water surface 114. Sensor 110 may be connected to recording vessel 102 with towing line 118 (or towing lines 118 for several closely spaced sensors 110). Towing line 118 may also be combined with a data line to provide real time monitoring of the acquired data. Sensor 110 may be positioned and maintained at a particular depth. For example, sensor 110 may be maintained at sensor depth 120 of approximately 250 meters. In some embodiments, sensor 110 may consist of multiple closely spaced sensors 110. In some embodiments, source 106 may be at a particular source depth 122 below the water surface 114, for example approximately ten meters. Source 106 can include an array of seismic energy sources towed behind source vessel 104. Multiple sources 106 may be at varied depths below surface 114. Although only one source 106 is shown on source towing line 124, any appropriate number of sources 106 may be connected to a particular source towing line 124. Additionally, multiple sources 106 may be positioned at a predetermined distance from one another, for example approximately three meters.

In some embodiments, source 106 emits a signal that propagates in all directions. Signals received by a sensor, such as sensor 110, may include direct arrival waves (W(t)) 152, and surface ghost waves (G(t)) 154. The far field signature may be expressed as: F(t)=W(t)+G(t). Bottom ghost waves 156 may be detected at sensor 110 when water depth 136 is not sufficiently large. For example, bottom ghost waves 156 may be seen when water depth 136 is less than approximately 800 meters. In some embodiments, when water depth 136 is sufficiently large, the effect of bottom ghost waves 156 is negligible. Thus, in embodiments of the present disclosure, the effect of bottom ghost waves may be disregarded.

In some embodiments, since the far field signature of a source is based on both direct arrival waves 152 and surface ghost waves 154, a change in position of either the source or sensor results in a change to the far field signature for that source. The change in position of either the source or sensor can be characterized by the direct incidence angle α. The far field signature for a source determined at a particular direct incidence angle α may then be used to analyze azimuthal seismic data gathered during a WAZ survey in which the sensors receive reflected signals from a source at reflected incidence angle α₁, (discussed with reference to FIG. 1A) approximately equivalent to direct incidence angle α. Direct incidence angle α may be determined based on a geometrical equation or set of equations.

For example, a signal may be received at sensor 110 from source 106. The position information for source 106 and sensor 110 may be determined and direct incidence angle α may be calculated as approximately 15°. The far field signature for source 106 may be determined for the particular direct incidence angle α. The far field signature at the particular direct incidence angle α can be subsequently used to analyze data collected during a survey in which a sensor receives reflected waves from a source at a similar or equivalent angle, for example approximately 15°.

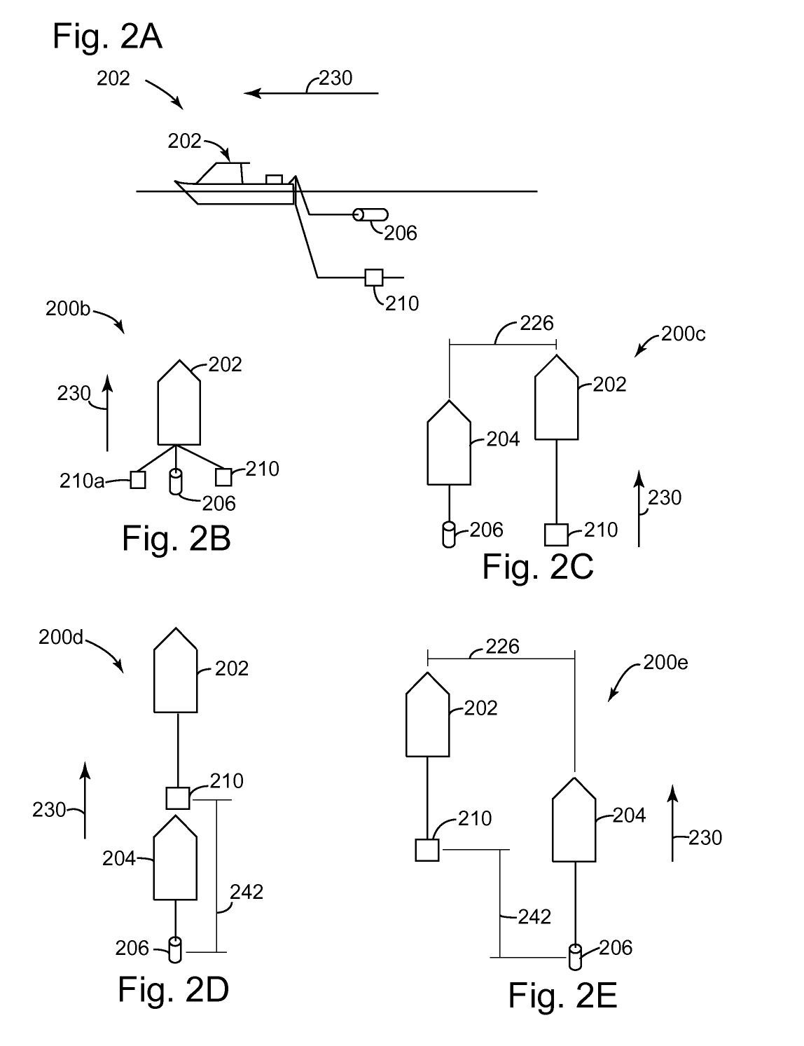

FIGS. 2A-2E illustrate exemplary views 200a-200e of configurations of source vessels 204 and recording vessels 202 used to determine the far field signature of source 206 in accordance with some embodiments of the present disclosure. Each view 200a-200e includes vessels that are traveling in a direction shown by directional arrow 230. FIG. 2A illustrates side view 200a of recording vessel 202 with sensor 210 approximately directly below source 206. In side view 200a, source 206 and sensor 210 are on the same vessel. Recording vessel 202 may or may not be towing streamers. View 200a may allow generation of a far field signature of source 206 for direct incidence angles 0°≦α≦10°.

FIG. 2B illustrates top view 200b of recording vessel 202 towing both source 206 and sensors 210a and 210b laterally offset from source 206. For example, each sensor 210a and 210b may be offset approximately forty meters from source 206. In top view 200b, source 206 and sensors 210 are on the same vessel. Recording vessel 202 may or may not be towing streamers. View 200b may allow generation of a far field signature of source 206 for direct incidence angles 10°≦α≦15°.

FIG. 2C illustrates top view 200c of recording vessel 202 with sensor 210 and source vessel 204 with source 206. Recording vessel 202 and source vessel 204 may travel approximately parallel to each other. Also, sensor 210 may be positioned at a particular depth, for example approximately 250 meters. Recording vessel 202 may or may not be towing streamers. Further, recording vessel 202 and source vessel 204 may be operated such that crossline distance 226 may vary. Different crossline distances 226 may allow different ranges of angles α to be utilized. For example, Table 1 below illustrates various maximum direct incidence angles αₘₐₓ based upon crossline distance 226 and sensor 210 at a depth of approximately 250 meters:

TABLE 1

| Crossline distance (m) | αₘₐₓ (degrees) |
|---|---|
| 100 | 22 |
| 200 | 39 |
| 350 | 54 |

FIG. 2D illustrates top view 200d of recording vessel 202 with sensor 210 and source vessel 204 with source 206. Recording vessel 202 and source vessel 204 may travel along approximately the same path, e.g., inline. Recording vessel 202 and source vessel 204 may be operated such that inline distance 242 may vary. Recording vessel 202 may or may not be towing streamers. Different inline distances 242 may be adjusted to allow different operational angles to be utilized. Operational angle is the direct incidence angle in the inline direction, as opposed to the crossline direction. For example, Table 2 below illustrates various operational angles achieved based upon inline distances 242 and sensor 210 at a depth of approximately 250 meters:

TABLE 2

| Inline distance (m) | Angle (degrees) |
|---|---|
| 100 | 40 |
| 200 | 58 |
| 350 | 70 |

FIG. 2E illustrates top view 200e of recording vessel 202 with sensor 210 and source vessel 204 with source 206. Recording vessel 202 and source vessel 204 may travel approximately parallel and with a separation defined by both offset distance 226 and offset length 242. Recording vessel 202 may or may not be towing streamers. In this embodiment, the crossline distance may be varied as discussed above with reference to FIG. 2C and the inline distance may be varied as discussed above with reference to FIG. 2D.

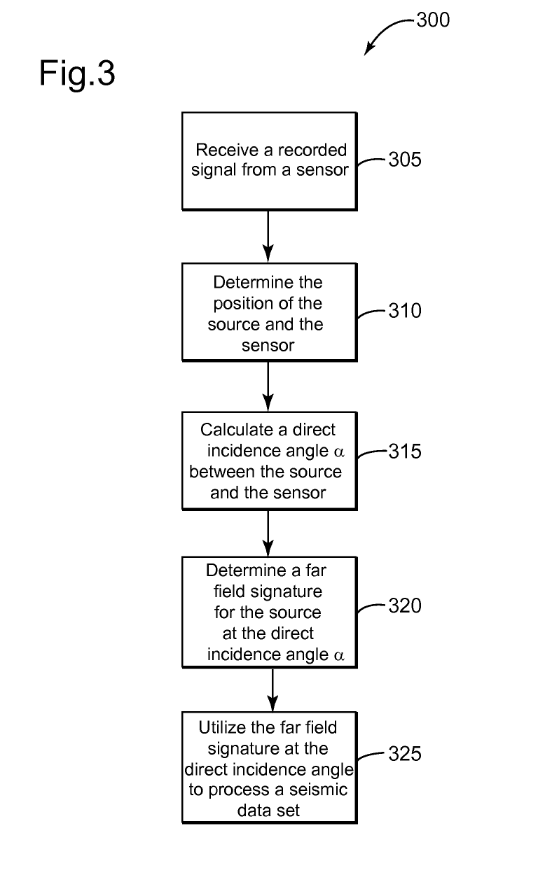

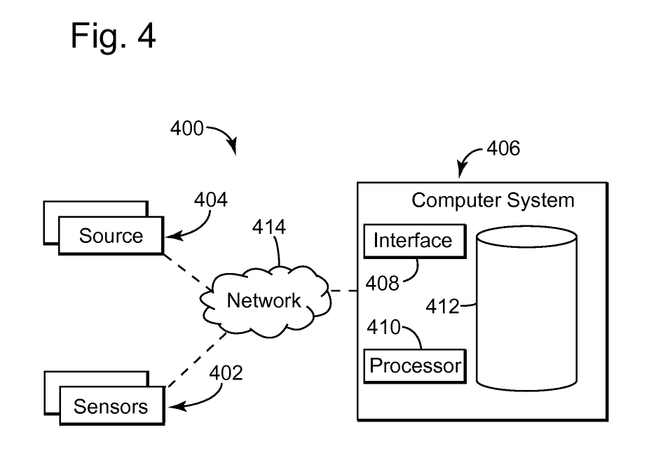

FIG. 3 illustrates a flow chart of an example method 300 for determining the far field signature of a source in accordance with some embodiments of the present disclosure. For illustrative purposes, method 300 is described with respect to source 106 in seismic survey system 150, discussed with respect to FIG. 1C; however, method 300 may be used to determine the far field signature of any appropriate source. The steps of method 300 can be performed by a user, electronic or optical circuits, various computer programs, models, or any combination thereof, configured to process seismic traces. The programs and models may include instructions stored on a non-transitory computer-readable medium and operable to perform, when executed, one or more of the steps described below. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer readable media. Collectively, the user, circuits, or computer programs and models used to process seismic traces may be referred to as a “computing system.” For example, the computing system may be computing system 406, discussed with reference to FIG. 4 below. In some embodiments, the computing system is located elsewhere, and receives information stored during the seismic survey. For example, computing system 406 may record seismic signals and position information and deliver them to an on-shore computing system for processing at a later time.

At step 305, the computing system receives a recorded signal from a sensor. For example, the computing system may receive a recorded signal from sensor 110, discussed with reference to FIG. 1C. In some embodiments, the computing system receives multiple recorded signals, each from a separate sensor. For example, the processing tool may receive separate recorded signals from multiple closely spaced sensors 110. In some embodiments, the computing system receives the recorded signals indirectly from the sensor. For example, computing system 406, discussed with reference to FIG. 4 below, may store recorded signals from sensor 110 and deliver them to a different computing system at a later time.

At step 310, the computing system determines the location of the sensor that provided the recorded signal and the source that emitted the signal that resulted in the recorded signal. For example, the computing system may determine the location and position of sensor 210 and source 206 in any of configurations discussed with reference to FIGS. 2A-2E. The computing system may use information from a USBL, depth sensors, GPS sensors, visible light or infrared transceivers, or any other mechanisms suitable for measuring the positions of sensors to determine the location of the sensor that provided the recorded signal.

At step 315, the computing system calculates the direct incidence angle α between the source and the sensor. For example, the computing system may use the position information from step 310 to determine the direct incidence angle α for direct arrival wave 152 as discussed with reference to FIG. 1C. Such a determination may be based on constructing a geometric equation.

At step 320, the computing system determines the far field signature for the source at the calculated direct incidence angle α. For example, as discussed with reference to FIG. 1C, the far field signature may be determined by characterizing the portion of the recorded signal that reflects the arrival of direct arrival wave 152 and surface ghost wave 126.

At step 325, the computing system utilizes the far field signature at the angle α to process a seismic data set. In some embodiments, the far field signature at the calculated direct incidence angle may be used in a signature deconvolution process applied to a seismic data set received at a sensor configured to receive signals from the source at approximately the same reflected incidence angle. The seismic data set may be gathered based on a WAZ survey where the reflected incidence angle between the sensors and the source is calculated.

Modifications, additions, or omissions may be made to method 300 without departing from the scope of the present disclosure. For example, the steps may be performed in a different order than that described and some steps may be performed at the same time. For example, in some embodiments, a seismic data set may be gathered at a particular reflected incidence angle, e.g., reflected incidence angle α₁ as discussed in step 325. Subsequently, the computing system may determine a configuration and locations for a source and sensor to determine the far field signature of the source. The configuration of the source and sensor may be based on producing a direct incidence angle that approximates the reflected incidence angle as discussed in step 310 and step 315. Further, more steps may be added or steps may be removed without departing from the scope of the disclosure.

FIG. 4 illustrates a schematic of an example seismic imaging system 400 that can be used to determine the far field signature of a source in accordance with some embodiments of the present disclosure. System 400 includes sources 404, sensors 402, and computer system 406 communicatively coupled via network 414, which can include one or more wired or wireless networks, or any suitable combination thereof.

Determining the far field signature of a source by computer system 406 can be used to improve seismic data and images generated from signals originating from sources 404. Computer system 406 can operate in conjunction with sources 404 and sensors 402 having any structure, configuration, or function described above with respect to FIGS. 1A-1C and 2A-2E. In some embodiments, sources 404 can be any suitable seismic energy sources. For example, sources 404 may be marine airguns, which generate a omnidirectional pressure wave. Any appropriate number of sources 404 may be used. Furthermore, sources 404 may be arranged in any appropriate geometry, such as an array, and positioned at any appropriate depth, according to the design of the seismic survey. For example, sources 404 may be coupled to a streamer line, a towing line, or maintained in a selected position or location using any other suitable positioning system.

Determination of a far field signature of a source by computer system 406 may use signals received by sensors 402. In some embodiments, sensors 402 detect pressure fluctuations in the surrounding water. Each sensor 402 detects reflected seismic waves received from sources 404 and transforms the reflected seismic waves into a seismic signals. A seismic signal may be digital sample data, an analog electrical signal, or any other appropriate representation of the seismic waves detected by the sensor. In some embodiments, sensors 402 may include geophones, hydrophones, accelerometers, fiber optic sensors (such as, for example, a distributed acoustic sensor (DAS)), or any suitable device. Such devices may be configured to detect and record energy waves propagating through subsurface geology with any suitable, direction, frequency, phase, or amplitude. For example, in some embodiments, sensors 402 are vertical, horizontal, or multicomponent sensors. As particular examples, sensors 402 may comprise three component (3C) hydrophones, 3C accelerometers, or 3C Digital Sensor Units (DSUs). System 400 may utilize any suitable number, type, arrangement, and configuration of sensors 402. For example, system 400 may include one, dozens, hundreds, thousands, or any suitable number of sensors 402. As another example, sensors 402 may have any suitable arrangement, such as linear, grid, array, or any other suitable arrangements, and spacing between sensors 402 may be uniform or non-uniform. Furthermore, sensors 402 may be located at any suitable depth.

Computer system 406 may include any suitable devices operable to process seismic data recorded by sensors 402. Computer system 406 is operable to process multiple sets of seismic data to determine far field signatures of sources and utilize the signatures in processing seismic data. Computer system 406 may be a single device or multiple devices. For example, computer system 406 may be one or more mainframe servers, desktop computers, laptops, cloud computing systems, or any suitable devices. Computer system 406 receives data recorded by sensors 402 and processes it to determine a far field signature for a source 404. Computer system 406 may be operable to perform the steps described above with respect to FIG. 3. Computer system 406 may also be operable to control certain sources 404. Computer system 406 may be communicatively coupled to sensors 402 via network 414 during the recording process, or it may receive the recorded data after the collection is complete. In the illustrated embodiment, computer system 406 includes network interface 408, processor 410, and memory 412.

Network interface 408 represents any suitable device operable to receive information from network 414, transmit information through network 414, perform suitable processing of information, communicate with other devices, or any combination thereof. Network interface 408 may be any port or connection, real or virtual, including any suitable hardware and/or software (including protocol conversion and data processing capabilities) to communicate through a LAN, WAN, or other communication system that allows computer system 406 to exchange information with network 414, other computer systems 406, sources 402, sensors 402, and/or other components of system 400. Computer system 406 may have any suitable number, type, and/or configuration of network interface 408.

Processor 410 communicatively couples to network interface 408 and memory 412 and controls the operation and administration of computer system 406 by processing information received from network interface 408 and memory 412. Processor 410 includes any hardware and/or software that operates to control and process information. In some embodiments, processor 410 may be a programmable logic device, a microcontroller, a microprocessor, any suitable processing device, or any suitable combination of the preceding. Computer system 406 may have any suitable number, type, and/or configuration of processor 410. Processor 410 may execute one or more sets of instructions to determine far field signatures, including the steps described above with respect to FIG. 3. Processor 410 may also execute any other suitable programs to facilitate the data stabilization such as, for example, user interface software to present one or more GUIs to a user.

Memory 412 stores, either permanently or temporarily, data, operational software, or other information for processor 410, other components of computer system 406, or other components of system 400. Memory 412 includes any one or a combination of volatile or nonvolatile local or remote devices suitable for storing information. For example, memory 412 may include random access memory (RAM), read only memory (ROM), flash memory, magnetic storage devices, optical storage devices, network storage devices, cloud storage devices, solid state devices, external storage devices, or any other suitable information storage device or a combination of these devices. Memory 412 may store information in one or more databases, file systems, tree structures, any other suitable storage system, or any combination thereof. Furthermore, different types of information stored in memory 412 may use any of these storage systems. Moreover, any information stored in memory may be encrypted or unencrypted, compressed or uncompressed, and static or editable. Computer system 406 may have any suitable number, type, and/or configuration of memory 412. Memory 412 may include any suitable information for use in the operation of computer system 406. For example, memory may store computer-executable instructions operable, when executed by processor 410, to perform the steps discussed above with respect to FIG. 3. Memory 412 may also store any seismic data or related data such as, for example, raw seismic data, 3D images, 4D images, weighting functions, or any other suitable information.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, “A and B” means “A and B, jointly or severally,” unless expressly indicated otherwise or indicated otherwise by context.

Particular embodiments may be implemented as hardware, software, or a combination of hardware and software. As an example and not by way of limitation, one or more computer systems may execute particular logic or software to perform one or more steps of one or more processes described or illustrated herein. Software implementing particular embodiments may be written in any suitable programming language (which may be procedural or object oriented) or combination of programming languages, where appropriate. In various embodiments, software may be stored in computer-readable storage media. Any suitable type of computer system (such as a single- or multiple-processor computer system) or systems may execute software implementing particular embodiments, where appropriate. A general-purpose computer system may execute software implementing particular embodiments, where appropriate. In certain embodiments, portions of logic may be transmitted and or received by a component during the implementation of one or more functions.

Herein, reference to a computer-readable storage medium encompasses one or more non-transitory, tangible, computer-readable storage medium possessing structures. As an example and not by way of limitation, a computer-readable storage medium may include a semiconductor-based or other integrated circuit (IC) (such as, for example, an FPGA or an application-specific IC (ASIC)), a hard disk, an HDD, a hybrid hard drive (HHD), an optical disc, an optical disc drive (ODD), a magneto-optical disc, a magneto-medium, a solid-state drive (SSD), a RAM-drive, or another suitable computer-readable storage medium or a combination of two or more of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of interface 408, one or more portions of processor 410, one or more portions of memory 412, or a combination of these, where appropriate. In particular embodiments, a computer-readable storage medium implements RAM or ROM. In particular embodiments, a computer-readable storage medium implements volatile or persistent memory.

This disclosure encompasses all changes, substitutions, variations, alterations, and modifications to the example embodiments herein that a person having ordinary skill in the art would comprehend. For example, while the embodiments of FIGS. 1A-1C and 2A-2E illustrate particular configurations of sources 106 and 206 and sensors 110 and 210, any suitable number, type, and configuration may be used. As yet another example, while this disclosure describes certain data processing operations that may be performed using the components of system 400, any suitable data processing operations may be performed where appropriate. Furthermore, certain embodiments may alternate between or combine one or more data processing operations described herein.

Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for seismic data processing, comprising:
determining a position of a first sensor and a source, wherein the first sensor is attached to a first vessel and the source is attached to a second vessel;
calculating a reflected incidence angle between the first sensor and the source;
determining a position for a second sensor based on a direct incidence angle between the second sensor and the source approximating the reflected incidence angle between the first sensor and the source; and
determining a far field signature for the source based on the direct incidence angle between the second sensor and the source.

2. The method of claim 1, further comprising processing a seismic data set utilizing the far field signature.

3. The method of claim 2, wherein the seismic data set is based on the reflected incidence angle.

4. The method of claim 1, further comprising positioning the second sensor and the source such that the reflected incidence angle is equal to the direct incidence angle.

5. The method of claim 1, wherein the second sensor is attached to a third vessel.

6. The method of claim 5, wherein the third vessel is configured to travel inline with the second vessel.

7. The method of claim 5, wherein the second vessel and the third vessel are configured to travel such that the second sensor and the source are parallel in the crossline direction.

8. The method of claim 0, further comprising utilizing the far field signature to generate an image of subsurface geological formations.

9. A seismic survey system, comprising:
a source configured to emit seismic waves;
a first sensor and a second sensor configured to transform seismic waves into a recorded signal; and
a computing system comprising:
a processor;
a memory communicatively coupled to the processor;
instructions stored in the memory that, when executed by the processor, cause the processor to:
determine a position of the first sensor and the source, wherein the first sensor is attached to a first vessel and the source is attached to a second vessel;
calculate a reflected incidence angle between the first sensor and the source;
determine a position for a second sensor based on a direct incidence angle between the second sensor and the source approximating the reflected incidence angle between the first sensor and the source; and
determine a far field signature for the source based on the direct incidence angle between the second sensor and the source.

10. The system of claim 9, wherein the instructions further cause the processor to process a seismic data set utilizing the far field signature.

11. The system of claim 10, wherein the seismic data set is based on the reflected incidence angle.

12. The system of claim 9, wherein the instructions further cause the processor to position the second sensor and the source such that the reflected incidence angle is equal to the direct incidence angle.

13. The system of claim 9, wherein the second sensor is attached to a third vessel.

14. The system of claim 13, wherein the third vessel is configured to travel inline with the second vessel.

15. The system of claim 13, wherein the second vessel and the third vessel are configured to travel such that the second sensor and the source are parallel in the crossline direction.

16. The system of claim 8, wherein the instructions further cause the processor to utilize the far field signature to generate an image of subsurface geological formations.

17. A non-transitory computer-readable medium, comprising instructions that, when executed by a processor, cause the processor to:
determine a position of a first sensor and a source, wherein the first sensor is attached to a first vessel and the source is attached to a second vessel;
calculate a reflected incidence angle between the first sensor and the source;
determine a position for a second sensor based on a direct incidence angle between the second sensor and the source approximating the reflected incidence angle between the first sensor and the source; and
determine a far field signature for the source based on the direct incidence angle between the second sensor and the source.

18. The non-transitory computer-readable medium of claim 17, wherein the instructions further cause the processor to process a seismic data set utilizing the far field signature.

19. The non-transitory computer-readable medium of claim 18, wherein the seismic data set is based on the reflected incidence angle.

20. The non-transitory computer-readable medium of claim 17, wherein the instructions further cause the processor to position the second sensor and the source such that the reflected incidence angle is equal to the direct incidence angle
